(19) United States
(12) Patent Application Publication
(10) Pub. No.: US 2024/0340392 A1
(43) Pub. Date: Oct. 10, 2024

(54) TRANSPORT MONITORING SYSTEM

(71) Applicant: Specten Corporation, Marysville, OH (US)

(72) Inventor: Gregory William Gerten, Marysville, OH (US)

(21) Appl. No.: 18/630,754

(22) Filed: Apr. 9, 2024

Related U.S. Application Data
(60) Provisional application No. 63/495,213, filed on Apr. 10, 2023.
(60) Provisional application No. 63/607,207, filed on Dec. 7, 2023.

(51) Int. Cl. H04N 7/18; H04N 23/54; H04N 23/66

(52) U.S. Cl. CPC H04N 7/183; H04N 23/54; H04N 23/66

(57) ABSTRACT

In certain aspects, a transport monitoring system for a transport vehicle is provided. The system includes an expandable mast. At least one sensor system is mechanically disposed on the expandable mast, wherein the at least one sensor system is configured to capture data within a field of view. A user device is in communication with the at least one sensor system, wherein the user device is configured to receive the data captured by the at least one sensor system.

### CROSS REFERENCE TO RELATED APPLICATIONS

The present application claims the benefit of priority under 35 U.S.C. § 119 from U.S. Provisional Patent Application Ser. No. 63/495,213, entitled “Transport Monitoring System,” filed on Apr. 10, 2023, and claims the benefit of priority under 35 U.S.C. § 119 from U.S. Provisional Patent Application Ser. No. 63/607,207, entitled “Transport Monitoring System,” filed on Dec. 7, 2023, all of both which are incorporated herein by reference in their entirety for all purposes.

### TECHNICAL FIELD

The present disclosure generally relates to monitoring systems, and more specifically relates to transport monitoring systems.

### BACKGROUND

Many industries utilize transport vehicles to carry loads. For example, in agriculture, transport vehicles can be utilized to haul grain and other harvests. Another example, is in the towing and recovery industries, where transport vehicles are utilized to carry cars and other vehicles. Loading and unloading can be difficult depending on the type of load, the surrounding environment, and potential complications in securing the load, to name a few. During loading, for instance, an operator of the transport vehicle may need to leave the transport vehicle multiple times to check on the load. In other instances, the operator may also have to move the transport vehicle into a better position for loading. Having to exit the vehicle during loading is often inconvenient and inefficient.

The description provided in the background section should not be assumed to be prior art merely because it is mentioned in or associated with the background section. The background section may include information that describes one or more aspects of the subject technology.

### SUMMARY

According to certain aspects of the present disclosure, a transport monitoring system for a transport vehicle is provided. The system includes an expandable mast. A sensor system is mechanically disposed on the expandable mast, wherein the sensor system is configured to capture data within a field of view. A user device is in communication with the sensor system, wherein the user device is configured to receive the data captured by the sensor system.

According to certain other aspects of the present disclosure, a transport monitoring system for a transport vehicle is provided. The system includes an expandable mast. A sensor system is mechanically disposed on the expandable mast, wherein the sensor system is configured to capture data within a field of view. A user device is in communication with the sensor system, wherein the user device is configured to receive the data captured by the sensor system. A server is in communication with the sensor system, wherein the server is configured to receive the data captured by the sensor system.

According to other aspects of the present disclosure, a transport monitoring system for a transport vehicle is provided. The system includes an expandable mast. A sensor system is mechanically disposed on the expandable mast, wherein the sensor system is configured to capture data within a field of view. A user device is in communication with the sensor system, wherein the user device is configured to receive the data captured by the sensor system. A actuator is in mechanical association with the expandable mast, wherein the actuator is configured to adjust the expandable mast between a first position and a second position.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A is a block diagram illustrating an example transport monitoring system according to certain aspects of the disclosure.

FIG. 1B is a block diagram illustrating an alternative example transport monitoring system according to certain aspects of the disclosure.

FIG. 2 is a block diagram illustrating the example device and controller of the transport monitoring system, according to certain aspects of the disclosure.

FIG. 3 is a block diagram illustrating an example computer system with which the example device and the controller of FIG. 2 can be implemented.

FIG. 4 is a block diagram illustrating another example transport monitoring system according to certain aspects of the disclosure.

FIG. 5A is a front view of a sensor system of at least one sensor system of the transport monitoring system according to certain aspects of the disclosure.

FIG. 5B is a top perspective view of the sensor system of the at least one sensor system of FIG. 5A according to certain aspects of the disclosure.

FIG. 6A is a perspective view of at least one mounting arm, in an open position, according to certain aspects of the disclosure.

FIG. 6B is a perspective view of the at least one mounting arm of FIG. 6A, in an intermediate position to support maneuvering, according to certain aspects of the disclosure.

FIG. 7 illustrates a user device displaying a view monitored by at least one sensor system, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various ways, all without departing from the scope of the present disclosure. Accordingly, the drawings and description are to be regarded as illustrative in nature and not restrictive.

The present disclosure provides a transport monitoring system with capabilities to adjustably view loads on a transport vehicle to provide operators of those transport vehicles with reliable, real-time data and alerts while in the transport vehicle or from another remote location. In certain aspects of the disclosed technology, machine learning algorithms are utilized to reduce false alerts regarding conditions of the load on the transport vehicles, increase the detection of positive alerts, and increase performance of the alert detections over time. The disclosed technology, in certain aspects, provides the ability to feed data to accounting and reporting services and/or tools for increased transportation automation of load details (e.g., load time, load location, load image, transport route, real-time updates, unload time, unload location, unload image, and security).

The disclosed technology can support various industries. For example, in agriculture and grain hauling, the disclosed technology allows an operator of a transport vehicle to remain in the transport vehicle while loading so as to move the vehicle when needed to ensure complete load fill without overloading and/or spilling. Another advantage in this industry is that the disclosed technology provides tracking loads from field to bins and estimates quantity hauled from the field to the bins. Additionally, the disclosed technology provides viewing capabilities under the transport vehicle (e.g., under the trailer) to view dumping of the grain. A viewer feed of the captured images/video, for example, can be provided to filling agents (e.g., harvesters, grain carts, etc).

As another example, in the towing and recovery industries, the disclosed technology allows the operators to ensure a secure load, report on images of loaded and unloaded vehicles, and provide load/unload time, load/unload location, and load/unload images. Yet another example in the cargo hauling industry, the disclosed technology allows the operator to remain in the truck while loading so as to move the truck when needed to ensure a complete load fill without overloading and triggering any proximity warning. Another advantage in the cargo hauling industry is that the disclosed technology provides tracking loads from pick up to unloading and estimated quantity hauled between sites. A viewer feed of the captured images/video, for example, can be provided to filling agents (e.g., forklift operators, cranes, etc).

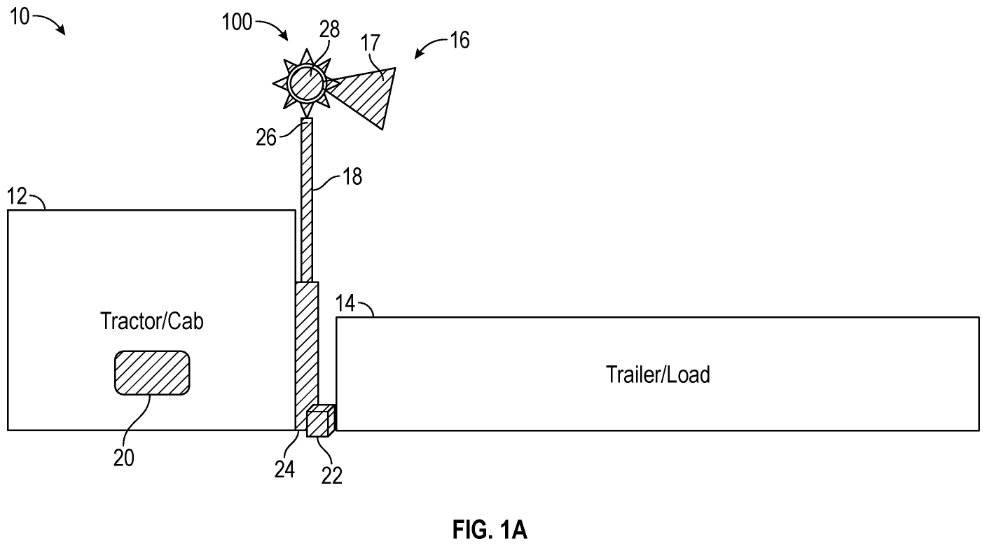

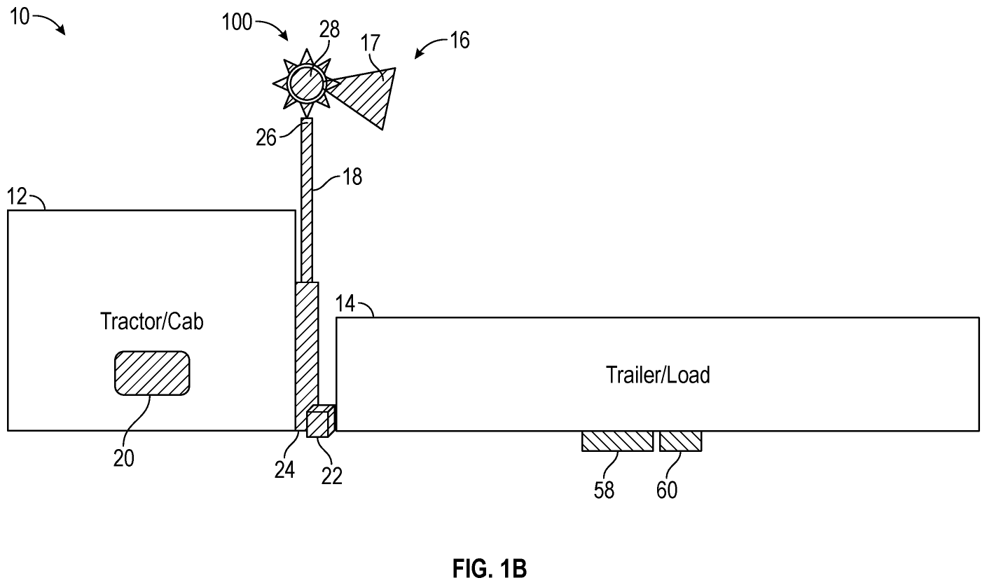

FIG. 1A illustrates an example transport monitoring system 100. The transport monitoring system 100 is configured for use with a transport vehicle 10. The transport vehicle 10 can be any appropriate vehicle for transporting loads such as, but not limited to, semitrucks, flatbed trucks, pickup trucks, tow trucks, and any other suitable transport vehicles. The transport vehicle 10 can be a semitruck, for example, with a tractor 12 and at least one trailer 14. Although the at least one trailer 14 is exemplarily illustrated, it should be understood that the tractor 12 can include any appropriate attached load, such as, but not limited to, a truck bed, a wagon, and a towed vehicle.

The transport monitoring system 100 includes at least one sensor system 16, including a first sensor system 17, an expandable mast 18, a user device 20, and a wireless controller 22. In certain aspects, the expandable mast 18 can be adjusted manually to be deployed, between a first position and a second position, into a desired position. In certain other aspects, the expandable mast 18 is in mechanical association with the wireless controller 22, which is in communication with the user device 20 for remotely adjusting the height of the expandable mast 18. In such aspects, the expandable mast 18 includes an actuator, which can be, but is not limited to, a spring, a pneumatic system with relays or an electrical system that are controlled via the wireless controller 22, via the user device 20, for adjusting the height of the expandable mast 18, and other appropriate actuating devices. The wireless controller 22 can be disposed externally or internally of the tractor 12.

A first end 24 of the expandable mast 18 is secured to the transport vehicle 10 while the first sensor system 17 of the at least one sensor system 16 is disposed at a second end 26 of the expandable mast 18. In certain aspects, the first sensor system 17 of the at least one sensor system 16 is mechanically secured to the second end 26 of the expandable mast 18 via a movable joint 28 and is configured to be selectively maneuverable to adjust a field of view (FOV) of the first sensor system 17 of the at least one sensor system 16 to monitor a load on the transport vehicle 10. The first sensor system 17 of the at least one sensor system 16 via the movable joint 28 is selectively maneuverable to include pan, tilt, and zoom capabilities for adjusting the FOV. In certain aspects, the user device 20 is in communication with the movable joint 28 and controls movability of the movable joint 28 to adjust the FOV of the first sensor system 17 of the at least one sensor system 16. In other aspects, a separate controller is associated with the movable joint 28 and controls movability of the movable joint 28 instead of the user device 20.

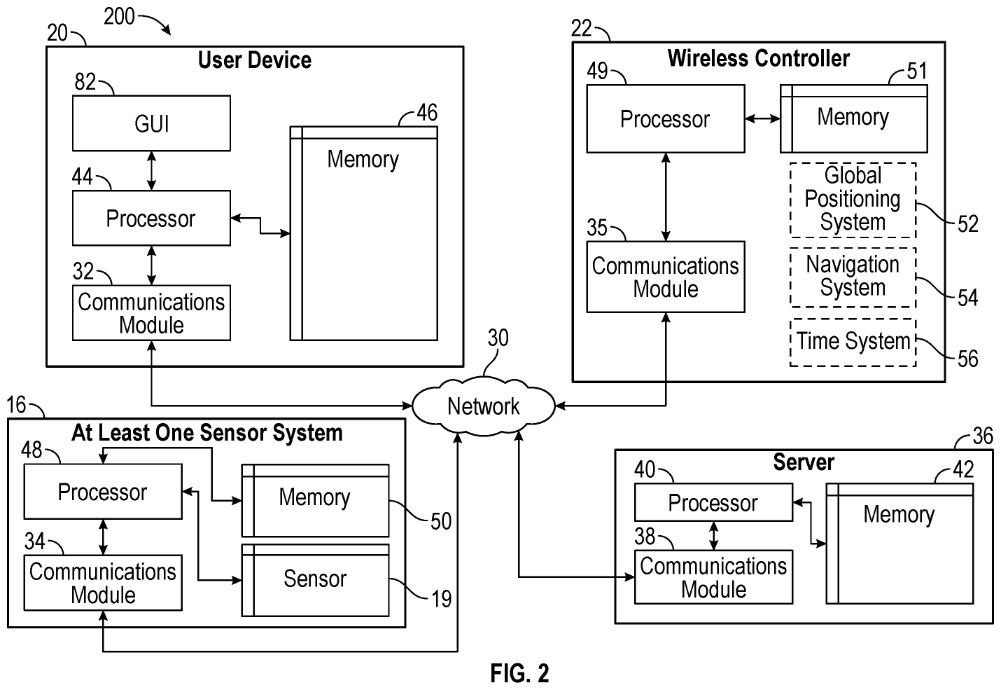

The first sensor system 17 of the at least one sensor system 16 includes at least one sensor 19 (as shown in FIG. 2) including, but not limited to, camera, video, radar, and microphone capabilities. In certain aspects, the at least one sensor system 16 includes multiple sensor systems each with camera, video, radar, and/or microphone capabilities including the first sensor system 17 and the secondary sensor system 58. For example, with respect to FIG. 1B, the at least one sensor system 16 further includes a secondary sensor system 58. The secondary sensor system 58 can be mounted to the exterior underside of the at least one trailer 14. In certain aspects, the secondary sensor system 58 is powered by a battery pack 60, which can also be mounted to the exterior underside of the at least one trailer 14. It should be understood that the at least one sensor system 16 can include any number of sensor systems.

The wireless controller 22 is configured to transmit control signals to the at least one sensor system 16 to control functions such as, but not limited to, pan, tilt, zoom and other appropriate functions. In certain aspects, with reference to FIG. 2, the wireless controller 22 optionally includes, in any combination of, a global positioning system 52, a navigation system 54, and a time system 56.

FIG. 2 is a block diagram 200 illustrating examples of the at least one sensor system 16, the user device 20, and the wireless controller 22, which are connected over a network 30 via respective communications modules 32, 34, 35. In certain aspects, the communications module 32 of the user device 20 and/or the communications module 34 of the at least one sensor system 16 and/or the communications module 35 of the wireless controller 22 are connected over the network 30 to a server 36 via its communications module 38. The communications modules 32, 34, 35, 38 are configured to interface with the network 30 to send and receive information, such as data, requests, responses, and commands to other devices on the network 30. The communications modules 32, 34, 35, 38 can be, for example, modems or Ethernet cards. In certain aspects, the communications module 34 is a router.

The network 30 can include, for example, any one or more of a personal area network (PAN), a local area network (LAN), a campus area network (CAN), a metropolitan area network (MAN), a wide area network (WAN), a broadband network (BBN), the Internet, and the like. Further, the network 30 can include, but is not limited to, any one or more of the following network topologies, including a bus network, a star network, a ring network, a mesh network, a star-bus network, tree or hierarchical network, and the like. In certain aspects, the communication modules 32, 34, 35 can provide a two-way data communication coupling via short-range communication such as using a Bluetooth, Wi-Fi, or other such transceiver.

The server 36 can be any device having an appropriate processor, memory, and communications capability for communicating with the user device 20, the wireless controller 22, and/or the at least one sensor system 16. For purposes of load balancing, the server 36 may include multiple servers. In certain aspects, the server 36 can be a cloud computing server of an infrastructure-as-a-service (IaaS) and be able to support a platform-as-a-service (PaaS) and software-as-a-service (SaaS) services. The server 36 includes a processor 40, the communications module 38, and a memory 42. The processor 40 of the server 36 is configured to execute instructions, such as instructions physically coded into the processor 40, instructions received from software in memory 42, or a combination of both. The processor 40 of the server 36 is configured to receive data, such as images and/or video, from the at least one sensor system 16. In certain aspects, the processor 40 of the server 36 is configured to analyze the data received from the at least one sensor system 16 and determine alerts, which can be transmitted to the user device 20, such as, but not limited to, loading conditions, unloading conditions, unstable load, theft, loading limitations, shifting load, proximity warning, and any other appropriate alerts. The alerts can be transmitted via text, email, apps, and any other appropriate communication. In certain aspects, the processor 40 of the server 36 is configured to set limits on the alerts including, but not limited to, loading, unloading, timing, geofencing, unstable load, theft warning, proximity level, load shift level, and other appropriate limits.

In certain aspects, the processor 40 of the server 36 is configured with a machine learning algorithm, which can determine and transmit the alerts to the user device 20. In certain aspects, the processor 40 of the server 36 is configured to analyze and process the data received from the at least one sensor system 16 and the wireless controller 22, including from any of the global positioning system 52, the navigation system 54, and the time system 56, to generate various reports including, but not limited to, loading time, loading position, transit time, unloading time, unloading position, any alerts during transit of the transport vehicle 10, and other appropriate reports. In certain aspects, the processor 40 of the server 36 is configured to transmit any of the analyzed data to other servers for fleet tracking and/or other management systems for permitting central command, control, and data collection, for example.

The user device 20, to which the at least one sensor system 16, the wireless controller 22, and the server 36 communicates with over the network 30, can be, for example, a tablet computer, a mobile phone, a mobile computer, a laptop computer, a portable media player, an electronic book (eBook) reader, or any other device having appropriate processor, memory, and communications capabilities. The user device 20 includes a processor 44, the communications module 32, and a memory 46. The processor 44 of the user device 20 is configured to execute instructions, such as instructions physically coded into the processor 44, instructions received from software in memory 46, or a combination of both. The processor 44 of the user device 20 is configured to receive and display images and/or video from the at least one sensor system 16. In certain aspects, the processor 44 of the user device 20 is configured to transit instructions to the wireless controller 22 to remotely adjusting the height of the expandable mast 18 between the first position and the second position. In certain aspects, the processor 44 of the user device 20 is configured to transmit instructions to the movable joint 28 to adjust the FOV of the at least one sensor system 16 to monitor a load on the transport vehicle 10, such as, on the at least one trailer 14. In other aspects, the processor 44 of the user device 20 is configured to transmit instructions directly to the at least one sensor system 16 to adjust the FOV of the at least one sensor system 16. The processor 44 of the user device 20 is configured to adjust pan, tilt, and zoom of the at least one sensor system 16 to adjust the FOV.

The at least one sensor system 16 can be, for example, any appropriate device with camera, video, radar, and/or microphone capabilities. The at least one sensor system 16 includes a processor 48, the communications module 34, and a memory 50. The processor 48 of the at least one sensor system 16 is configured to execute instructions, such as instructions physically coded into the processor 48, instructions received from software in memory 50, or a combination of both. The processor 48 of the at least one sensor system 16 is configured to capture data, such as, but not limited to, images, measurements, and/or video within the FOV to monitor a load on a rear section of the transport vehicle 10. The processor 48 of the at least one sensor system 16 is configured to transmit the captured data, such as the images and/or video, to the user device 20 and/or the server 36, where, in certain aspects, the user device 20 and/or the server 36 can process and analyze the captured data. In certain aspects, the processor 48 of the at least one sensor system 16 is configured to perform analysis on the captured data. In certain aspects, the processor 48 of the at least one sensor system 16 is configured with a machine learning algorithm, which can determine and transmit alerts to the user device 20 and/or the server 36 about conditions such as, but not limited to, loading conditions, unloading conditions, unstable load, theft, loading limitations, shifting load, proximity warning, and any other appropriate alerts. The alerts can be transmitted via text, email, apps, and any other appropriate communication.

In certain aspects with the secondary sensor system 58 of the at least one sensor system 16, which can be any appropriate device with camera, video, radar, and/or microphone capabilities, the secondary sensor system 58 is configured to capture data, such as, but not limited to, images and/or video under the at least one trailer 14. The secondary sensor system 58 is configured to transmit the captured data to the user device 20 and/or the server 36, where, in certain aspects, the user device 20 and/or the server 36 can process and analyze the captured data.

The wireless controller 22 can be any device having an appropriate processor, memory, and communications capability for communicating with the user device 20, the at least one sensor system 16, and the server 36. The wireless controller 22 includes a processor 49, the communications module 35, and a memory 51. The processor 47 of the wireless controller 22 is configured to execute instructions, such as instructions physically coded into the processor 49, instructions received from software in memory 51, or a combination of both. The processor 47 of the wireless controller 22 is configured to transmit control signals to the at least one sensor system 16 to control functions such as, but not limited to, pan, tilt, zoom and other appropriate functions. The processor 47 of the wireless controller 22 is configured to receive camera, video, radar, and/or microphone signals from the at least one sensor system 16 and to transmit those signals to the server 36 for analysis and processing. The processor 47 of the wireless controller 22 is configured to transmit location signals from the global positioning system 52 to the server 36 to identify positioning of the transport vehicle 10.

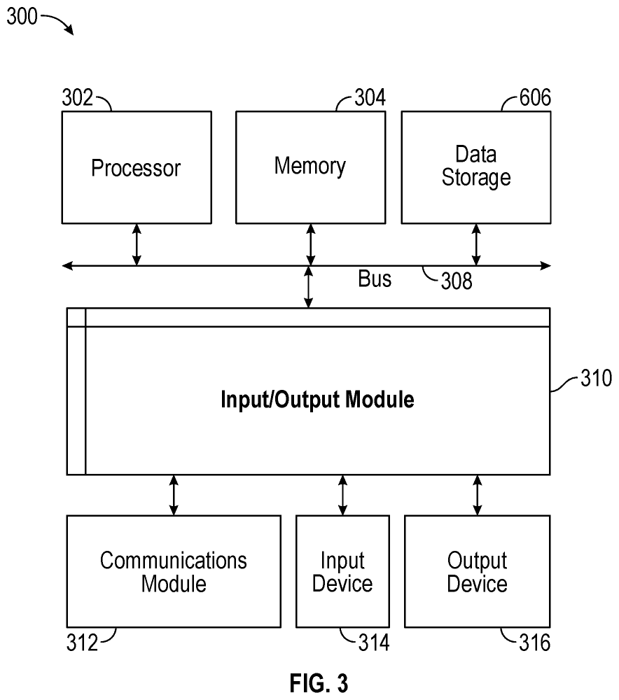

FIG. 3 is a block diagram illustrating an example computer system 300 with which the user device 20, the at least one sensor system 16, the wireless controller 22, and the server 36 can be implemented. In certain aspects, the computer system 300 may be implemented using hardware or a combination of software and hardware, either in a dedicated server, or integrated into another entity, or distributed across multiple entities.

Computer system 300 (e.g., the user device 20, the at least one sensor system 16, the wireless controller 22, and the server 36) includes a bus 308 or other communication mechanism for communicating information, and a processor 302 (e.g., the processor 40, 44, 48) coupled with bus 308 for processing information. According to one aspect, the computer system 300 can be a cloud computing server of an IaaS that is able to support PaaS and SaaS services.

Computer system 300 can include, in addition to hardware, code that creates an execution environment for the computer program in question, e.g., code that constitutes processor firmware, a protocol stack, a database management system, an operating system, or a combination of one or more of them stored in an included memory 304 (e.g., the memory 42, 46, 50), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 308 for storing information and instructions to be executed by processor 302. The processor 302 and the memory 304 can be supplemented by, or incorporated in, special purpose logic circuitry.

The instructions may be stored in the memory 304 and implemented in one or more computer program products, e.g., one or more modules of computer program instructions encoded on a computer readable medium for execution by, or to control the operation of, the computer system 300.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 300 further includes a data storage device 306 such as a magnetic disk or optical disk, coupled to bus 308 for storing information and instructions. Computer system 300 may be coupled via input/output module 310 to various devices. The input/output module 310 can be any input/output module. Example input/output modules 310 include data ports such as USB ports. In addition, input/output module 310 may be provided in communication with processor 302, so as to enable near area communication of computer system 300 with other devices. The input/output module 310 may provide, for example, for wired communication in some implementations, or for wireless communication in other implementations, and multiple interfaces may also be used. The input/output module 310 is configured to connect to a communications module 312. Example communications modules 312 (e.g., the communications module 32, 34, 38) include networking interface cards, such as Ethernet cards and modems. In certain aspects, communications module 312 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In certain aspects, the input/output module 310 is configured to connect to a plurality of devices, such as an input device 314, and/or an output device 316. Example input devices 314 include a keyboard and a pointing device, e.g., a mouse or a trackball, by which a user can provide input to the computer system 300. Other kinds of input devices 314 can be used to provide for interaction with a user as well, such as a tactile input device, visual input device, audio input device, or brain-computer interface device.

According to one aspect of the present disclosure the user device 20, the at least one sensor system 16, the wireless controller 22, and the server 36 can be implemented using a computer system 300 in response to processor 302 executing one or more sequences of one or more instructions contained in memory 304. Such instructions may be read into memory 304 from another machine-readable medium, such as data storage device 306. Execution of the sequences of instructions contained in main memory 304 causes processor 302 to perform the process steps described herein. One or more processors in a multi-processing arrangement may also be employed to execute the sequences of instructions contained in memory 304. Processor 302 may process the executable instructions and/or data structures by remotely accessing the computer program product, for example by downloading the executable instructions and/or data structures from a remote server through communications module 312 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 302 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 308. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

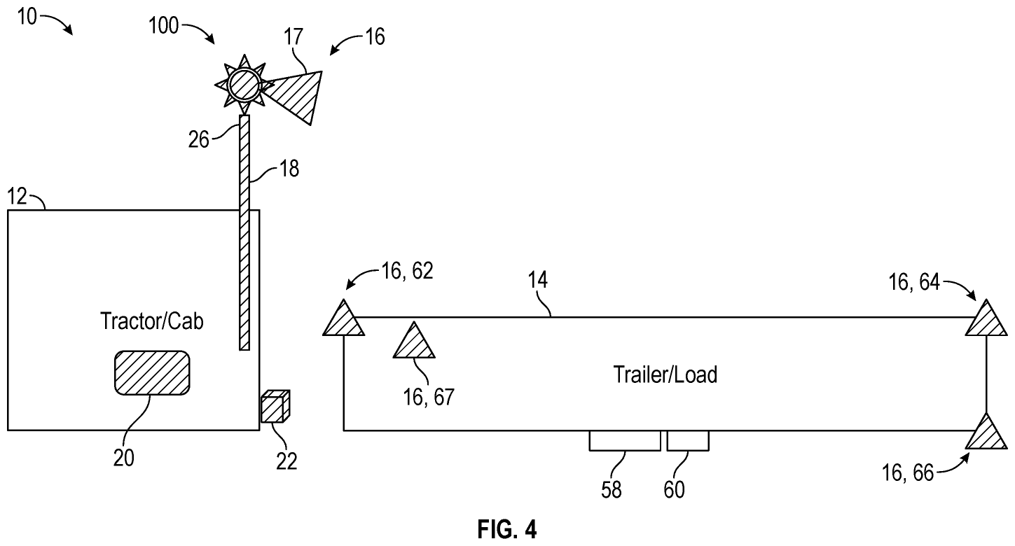

Referring to FIG. 4, in certain other aspects, the at least one sensor system 16 includes multiple sensor systems, with camera, video, radar, and/or microphone capabilities, in addition to the first sensor system 17 and the secondary sensor system 58, such as a third sensor system 62, a fourth sensor system 64, and a fifth sensor system 66. Each of the senor systems of the at least one sensor system 16 can be strategically located with respect to the transport vehicle 10. For example, the first sensor system 17 and the secondary sensor system 58 are positioned as described above with reference to FIG. 1B, while the third sensor system 62 is located at the front of the at least one trailer 14, and the fourth sensor system 64 and the fifth sensor system 66 are located at the rear of the at least one trailer 14. In certain aspects, the third sensor system 62 is mounted at the front of the at least one trailer 14, and the fourth sensor system 64 and the fifth sensor system 66 are mounted at the rear of the at least one trailer 14, as explained in further detail below. In certain aspects, another sensor system, such as a sixth sensor system 67, is optionally disposed in the interior of the at least one trailer 14 to monitor loads therein such as, but not limited to, animals, pellets, and other appropriate loads. In such aspects, the sixth sensor system 67 is configured to identify labels and tracking identification on any of the loads, which can be transmitted to an appropriate service for tracking of the load.

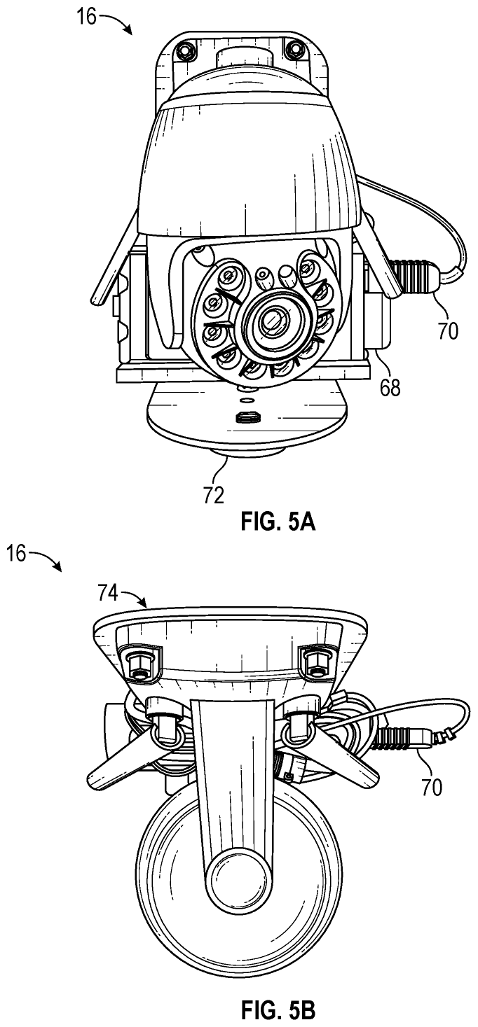

With reference to FIGS. 5A and 5B, in certain aspects, for example, the at least one sensor system 16, such as the first sensor system 17, the secondary sensor system 58, the third sensor system 62, the fourth sensor system 64, and the fifth sensor system 66, includes a rechargeable battery pack 68, which can be a rechargeable solar battery pack, that powers the at least one sensor system 16. In certain aspects, the at least one sensor system 16 includes a voltage converter 70 (e.g., a 5V DC to 12V DC converter) connected to the rechargeable battery pack 68 to convert the voltage from the rechargeable battery pack 68 to the at least one sensor system 16. In certain aspects, the at least one sensor system 16, such as the first sensor system 17, the secondary sensor system 58, the third sensor system 62, the fourth sensor system 64, and the fifth sensor system 66, includes a first magnetic mount 72 and a second magnetic mount 74, which facilitate mounting of the at least one sensor system 16 to the at least one trailer 14. In certain aspects, the first magnetic mount 72 is disposed at the bottom of the at least one sensor system 16 and the second magnetic mount 74 is disposed at the back of the at least one sensor system 16. Although the first magnetic mount 72 and the second magnetic mount 74 are described as magnetic, it should be understood that other types of mountings are within the scope of the present disclosure.

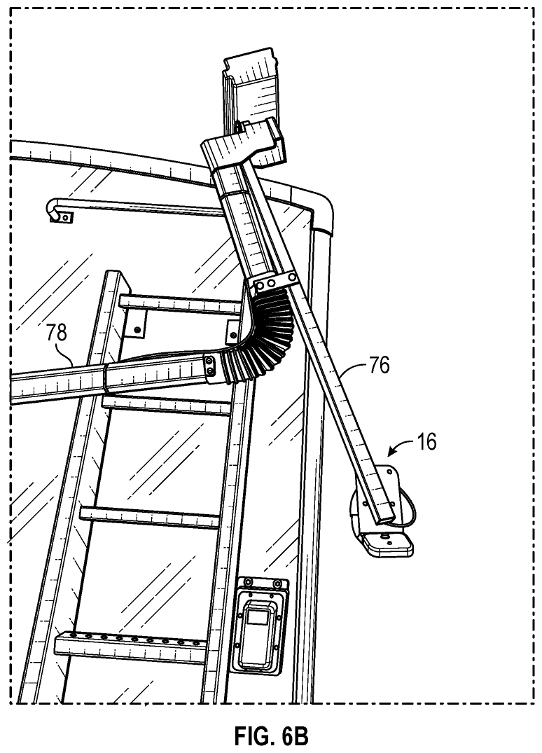

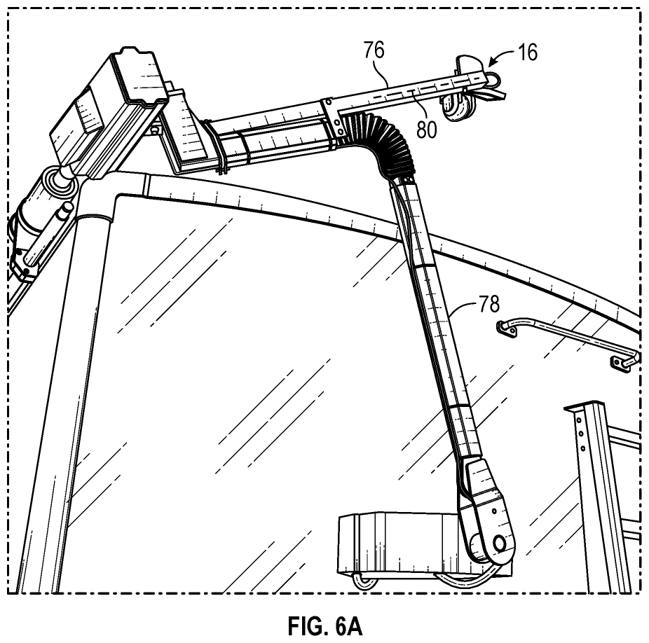

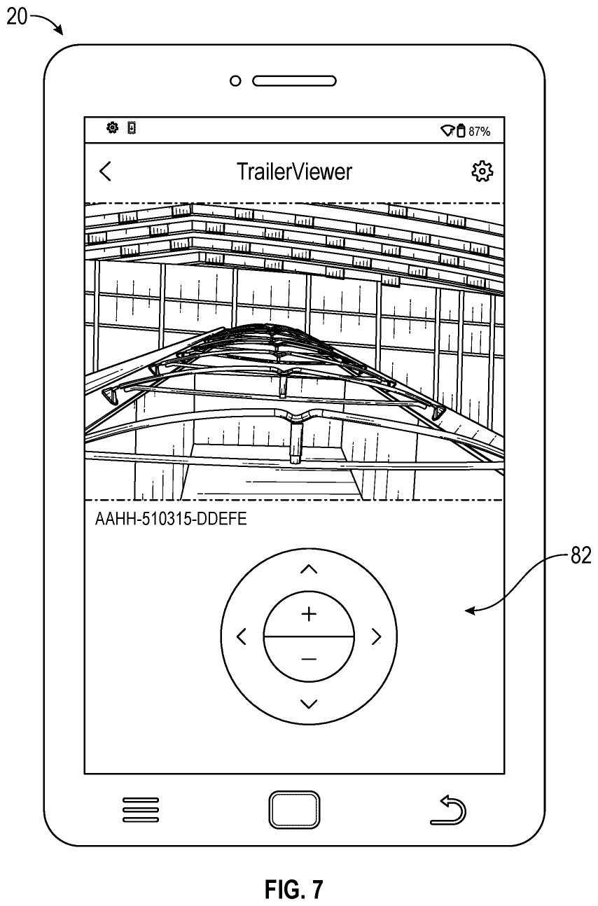

Referring to FIGS. 6A and 6B, in other aspects, the transport monitoring system 100 includes at least one mounting arm 76 mechanically coupling the at least one sensor system 16 to the at least one trailer 14. For example, one of the sensor systems of the at least one sensor system 16, such as the third sensor system 62, is coupled to the at least one trailer 14 via the at least one mounting arm 76, which is mounted to a tarp arm 78 that is mechanically connected to the front of the at least one trailer 14. The tarp arm 78 works in conjunction with another tarp arm (not shown) mechanically connected to the back of the at least one trailer 14. From an open position, as shown in FIG. 6A, the tarp arm 78 is configured to unwind a tarp (not shown) over the top of the at least one trailer 14 through an intermediate position, as shown in FIG. 6B, to a closed position (not shown). In the intermediate position, the at least one mounting arm 76 is located such that it supports maneuverability. In the open position, the at least one sensor system 16 can monitor a view of the loading process into the at least one trailer 14 and transmit the view for display on the user device 20, as exemplarily illustrated in FIG. 7. The view can be a live feed of the loading process. A graphical user interface 82 is exemplarily illustrated in FIG. 7. The graphical user interface 82 is configured to display controls for controlling the expandable mast 18, controlling the pan, tilt, and zoom of the at least one sensor system 16, controlling the camera, video, radar, and microphone capabilities of the at least one sensor system 16, and other appropriate functionalities of the transport monitoring system 100.

In certain other aspects, the at least one mounting arm 76 includes an extendible piston 80 mechanically disposed therein that is attached to the at least one sensor system 16, such as the third sensor system 62. The extendible piston 80 is configured to operatively extend the at least one sensor system 16 outwardly from the at least one mounting arm 76. The extendible piston 80 can be operated via control signals from the user device 20 or can be operated manually. Although the at least one mounting arm 76 is described above as being mounted to the tarp arm 78, it should be understood that the at least one mounting arm 76 could, alternatively or additionally, be mounted to the other tarp arm mechanically disposed at the back of the at least one trailer 14. It should also be understood that the tarp arm 78 could be mechanically disposed at other locations on the at least one trailer 14.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A transport monitoring system for a transport vehicle, comprising:
an expandable mast;
at least one sensor system mechanically disposed on the expandable mast, wherein the at least one sensor system is configured to capture data within a field of view; and
a user device in communication with the at least one sensor system, wherein the user device is configured to receive the data captured by the at least one sensor system.

2. The transport monitoring system of claim 1, further comprising a server in communication with the at least one sensor system, wherein the server is configured to receive the data captured by the at least one sensor system.

3. The transport monitoring system of claim 2, wherein the server is configured to analyze the data received from the at least one sensor system and determine alerts based on the data received from the at least one sensor system.

4. The transport monitoring system of claim 3, wherein the server is configured to transmit the alerts to the user device.

5. The transport monitoring system of claim 3, wherein the alerts comprise one of loading conditions, unloading conditions, unstable load, theft, loading limitations, shifting load, and proximity warning.

6. The transport monitoring system of claim 3, wherein the server is configured with a machine learning algorithm for analyzing the data received from the at least one sensor system to determine the alerts.

7. The transport monitoring system of claim 1, wherein the expandable mast comprises an actuator configured to adjust the expandable mast between a first position and a second position.

8. The transport monitoring system of claim 7, further comprising a wireless controller in communication with the actuator and the user device, wherein the user device is configured to transmit instructions to the wireless controller to control the actuator for adjusting the expandable mast between the first position and the second position.

9. The transport monitoring system of claim 1, further comprising at least one mounting arm extendibly coupled to a second sensor system of the at least one sensor system, wherein the at least one mounting arm is couplable to at least one trailer of the transport vehicle.

10. A transport monitoring system for a transport vehicle, comprising:
an expandable mast;
at least one sensor system mechanically disposed on the expandable mast, wherein the at least one sensor system is configured to capture data within a field of view;
a user device in communication with the at least one sensor system, wherein the user device is configured to receive the data captured by the at least one sensor system; and
a server in communication with the at least one sensor system, wherein the server is configured to receive the data captured by the at least one sensor system.

11. The transport monitoring system of claim 10, wherein the expandable mast comprises an actuator configured to adjust the expandable mast between a first position and a second position.

12. The transport monitoring system of claim 11, further comprising a wireless controller in communication with the actuator and the user device, wherein the user device is configured to transmit instructions to the wireless controller to control the actuator for adjusting the expandable mast between the first position and the second position.

13. The transport monitoring system of claim 10, wherein the server is configured to analyze the data received from the at least one sensor system and determine alerts based on the data received from the at least one sensor system.

14. The transport monitoring system of claim 13, wherein the server is configured to transmit the alerts to the user device.

15. The transport monitoring system of claim 13, wherein the alerts comprise one of loading conditions, unloading conditions, unstable load, theft, loading limitations, shifting load, and proximity warning.

16. The transport monitoring system of claim 13, wherein the server is configured with a machine learning algorithm for analyzing the data received from the at least one sensor system to determine the alerts.

17. A transport monitoring system for a transport vehicle, comprising:
an expandable mast;
at least one sensor system mechanically disposed on the expandable mast, wherein the at least one sensor system is configured to capture data within a field of view;
a user device in communication with the at least one sensor system, wherein the user device is configured to receive the data captured by the at least one sensor system; and
an actuator in mechanical association with the expandable mast, wherein the actuator is configured to adjust the expandable mast between a first position and a second position.

18. The transport monitoring system of claim 17, further comprising a wireless controller in communication with the actuator and the user device, wherein the user device is configured to transmit instructions to the wireless controller to control the actuator for adjusting the expandable mast between the first position and the second position.

19. The transport monitoring system of claim 17, further comprising a server in communication with the at least one sensor system, wherein the server is configured to receive the data captured by the at least one sensor system.

20. The transport monitoring system of claim 19, wherein the server is configured to analyze the data received from the at least one sensor system and determine alerts based on the data received from the at least one sensor system.
